(19) United States
(12) Patent Application Publication
(10) Pub. No.: US 2010/0212520 A1
(43) Pub. Date: Aug. 26, 2010

(54) DEVICE FOR REMOVING COFFEE GROUNDS FROM SPECIAL COFFEE CAPSULES MADE OF ALUMINIUM AND FOR REDUCING THE SIZE OF SAID CAPSULES

(76) Inventor: Guy-Jacques Franssen, Chenee (BE)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/598,913

(22) PCT Filed: Apr. 23, 2008
(86) PCT No.: PCT/IB08/01240

§ 371 Date: Mar. 12, 2010

(30) Foreign Application Priority Data
May 14, 2007 (FR) 0703546

(51) Int. Cl. B30B 13/00; B30B 9/00

(52) U.S. Cl. 100/35; 100/102

(57) ABSTRACT

The invention relates to a method for separating the aluminium of used coffee capsule by removing the coffee grounds therefrom and by reducing the overall dimensions by crushing them for recycling. The device includes an emptying piston (2) for punching the body of the used capsule (1) in order to turn the housing inside out. The coffee grounds (5) are ejected by the explosion of the perforated wall and are recovered in a first vessel. After removing the emptying piston (2), a lateral movement piston (3) urges the empty capsule towards a crushing piston (4). The crushed capsule (17) then falls into a second vessel intended therefore. The actuation of the operational handle (7) of the coffee machine (10) controls the pistons (2, 3, 4). The device is intended for separating coffee residue from aluminium.

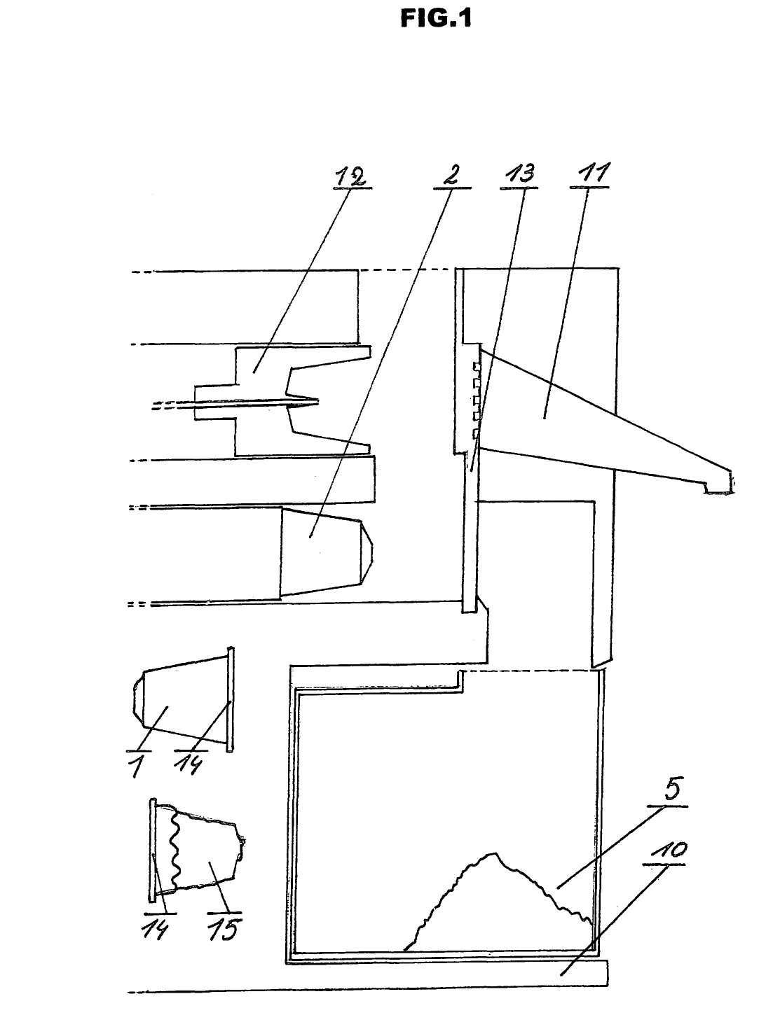

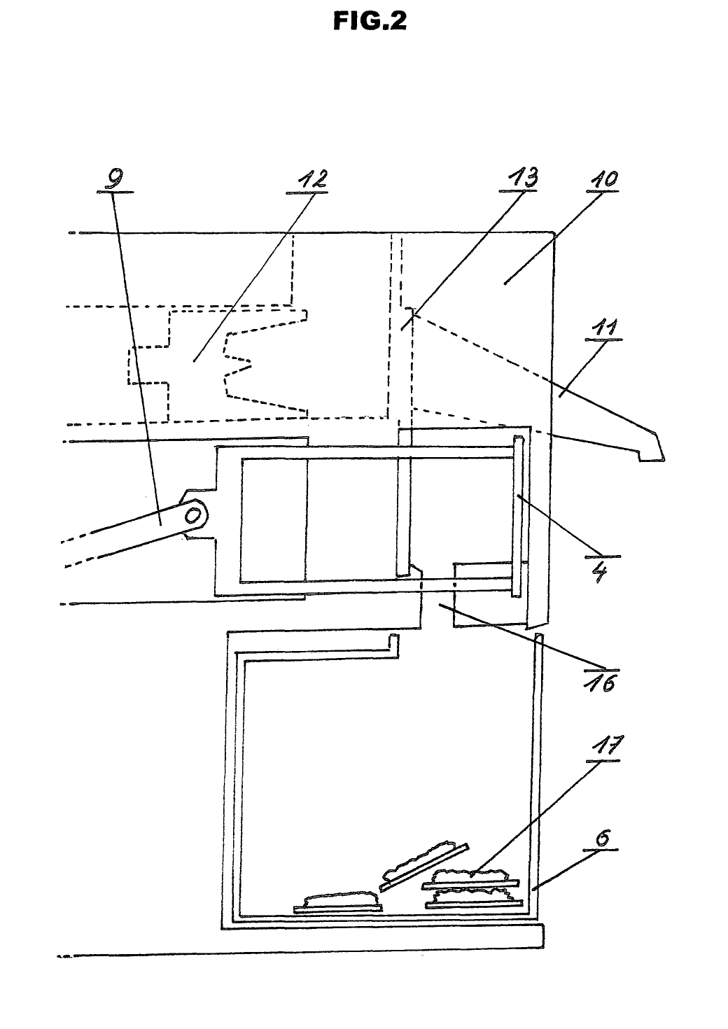

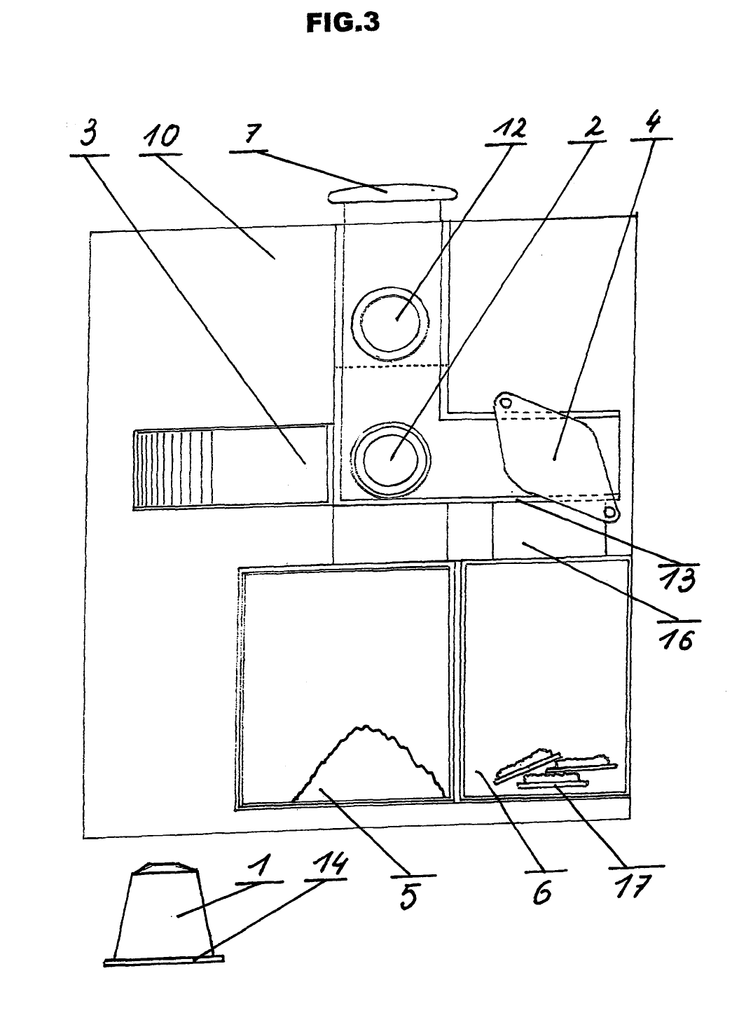

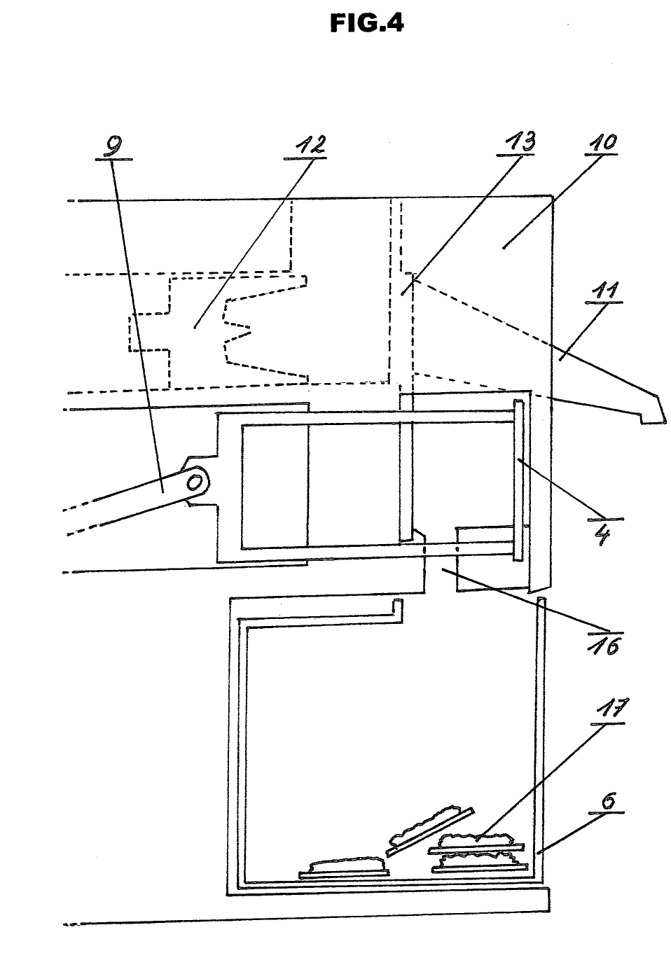

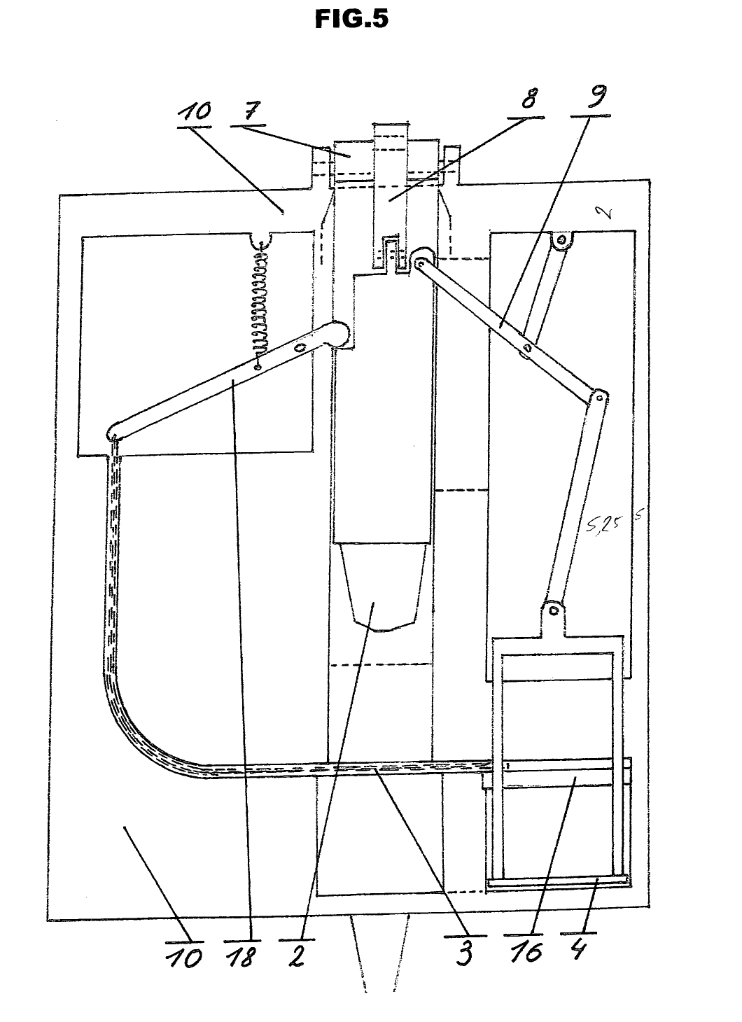

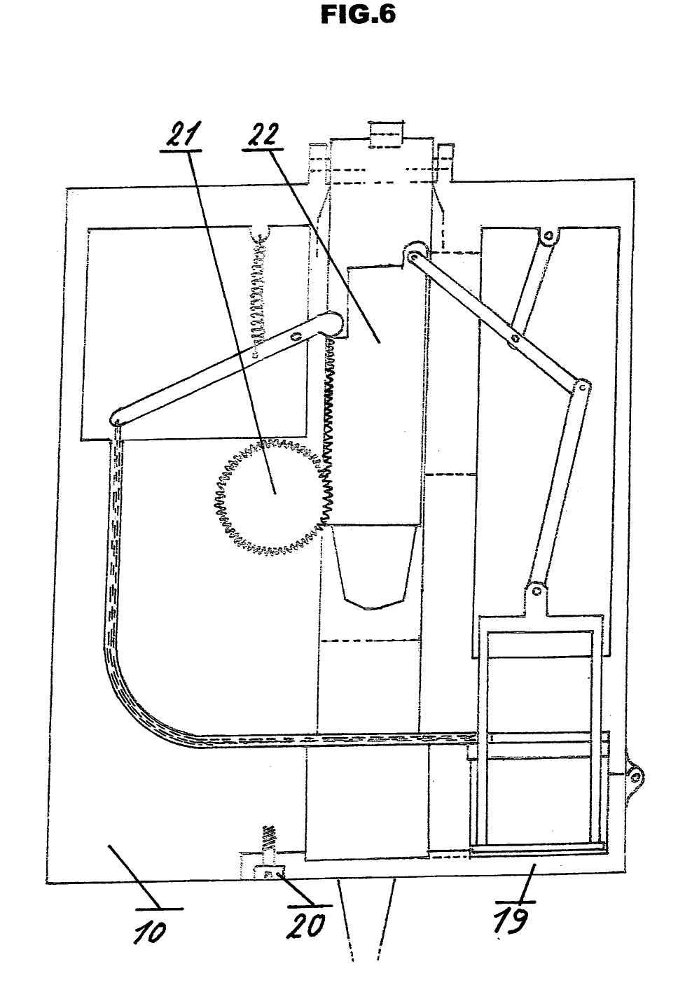

The present invention relates to a device designed to empty coffee grounds from special coffee capsules made of aluminum and to reduce their size.

The device is integrated into espresso machines using rigid aluminum capsules.

To date, used capsules (1) are discarded into normal garbage; the aluminum cannot be recycled and is thus lost.

The device enables, firstly, to evert the capsules in order to empty them into a coffee grounds reservoir (5) and then compress them to reduce their bulk.

The emptied and reduced capsules (17) are recovered in a second reservoir (6).

After several uses, the coffee grounds can be discarded into normal garbage and the aluminum into the recycle bin.

The device comprises a discharge piston (2), a lateral displacement piston (3), a crushing piston (4), and two recuperation receptacles (5), (6). All these elements are integrated into the body of the coffee maker (10).

A modification of existed elements of the machine must be made in order to combine the device with it.

The coffee spout (11) must be lengthened and the body (10) in front of the machine must be expanded in order to incorporate the device of the invention.

The recuperation receptacle currently located under the spout (11) is replaced by a residue collecting reservoir (5) on the left and a capsule collecting reservoir (6) on the right.

The device of the invention is located under the coffee production mechanism (12).

After flow of the coffee, this device goes into operation.

By the opening of the handle (7), the used capsule (1) is released from the coffee production mechanism (12) and drops a few centimeters allowing access to a new capsule.

The flange (14) of the used capsule (1) slides in the ejection grooves (13). These grooves (13) force the capsule (1) to be positioned opposing the discharge piston (2).

The discharge piston (2) is positioned under the production mechanism (12) in order to receive the used capsule (1).

By closing the handle (7) for a new usage, the part of it (2) comes into contact with the used capsule (1). This piston (2) has a shape inverse of the latter (1) so as to enable eversion of the contour and piercing of the thin wall perforated upon use and thus empty the coffee grounds into the receptacle (5) provided for this purpose.

By a lever system (8), the manipulation of the handle (7) controls the movement of the discharge piston (2). The stroke of the latter is double the stroke of the coffee production mechanism (12).

By the opening of the handle (7), the discharge piston (2) re-emerges from the everted capsule (15) and releases it. The displacement piston (3), controlled by the return of the discharge piston (2), actuated by a lever and spring (18), comes into contact with the latter (1) to conduct the capsule laterally a few centimeters toward the right while maintaining the same plane. This displacement piston (3) is thin so as to act solely on the flange (14) of the capsule (1). It is made of flexible material and slides in a groove comprising a curve of 90°. Its stroke is sufficiently long in order to obtain the desired movement.

The capsule (1) is immobilized opposing the crushing piston (4). The grooves (13) as well as the evacuation space (16) are designed in order to prevent the capsule (15) from descending into the recuperation receptacle before being reduced in thickness by the crushing piston (4).

By the closing of the handle (7), the movement of the crushing piston (4) is actuated toward the rear by the lever (9) in order to compress the repoussé portion of the capsule in order to flatten it.

The stroke of the latter is opposite in direction to the coffee production piston (12).

At the opening of the handle (7), the crushing piston (4) draws away and allows the capsule (17) to drop into the receptacle provided for that purpose.

By the opening and closing of the handle (7), the capsules follow each other in the system. Three openings and closings will thus be required to completely empty the device.

An improvement of the invention can be brought about by a modification of the body of the coffee maker (10).

A pivotable front face (19) enables easy cleaning of the system. A blocking screw (20) maintains the face in closed position during use.

A motor (21), driving the modified discharge piston (22), can also be added to facilitate the operation of the handle.

1) A device integrated into an espresso machine designed to empty coffee grounds from special coffee capsules made of aluminum and to reduce their size, characterized in that it comprises a discharge piston (2) designed to stamp used capsules (1) in order to empty their contents into a receptacle (5), a lateral displacement piston (3) orienting them toward a crushing piston (4) designed to reduce their thickness and a second recuperation receptacle (6) for the crushed capsules (17).

2) A device according to claim 1 characterized by the use of a motor to actuate the pistons during the use of the system.

3) A device according to all of the claims characterized in that the device has a removable front face to enable maintenance.

4) A method of emptying coffee grounds from coffee capsules made of aluminum and reduction of their size, using a device according to one of the preceding claims, characterized in that it comprises the following steps: separation of the coffee grounds from the capsule by stamping the contour of it causing the breakup of the thin wall, the lateral displacement of the emptied capsule and the reduction of its thickness by crushing.
